(19) United States
(12) Patent Application Publication
(10) Pub. No.: US 2013/0149086 A1
(43) Pub. Date: Jun. 13, 2013

(54) TRANSPORT DECK FOR A PICKUP TRUCK

(71) Applicant: DAN RAILSBACK, Wymore, NE (US)

(72) Inventor: DAN RAILSBACK, Wymore, NE (US)

(21) Appl. No.: 13/315,402

(22) Filed: Dec. 9, 2011

(51) Int. Cl. B60P 1/30

(52) U.S. Cl. 414/478

(57) ABSTRACT

A transport deck is disclosed which is movably mounted in the box of a pickup truck so as to be selectively movable from a transport position within the box of the pickup truck to a loading/unloading rearwardly of the pickup truck. The transport deck includes a support deck which is in a horizontally disposed position when the transport deck is in its transport position and when the transport deck in its loading/unloading position.

### BACKGROUND OF THE INVENTION

1. Field of the Invention

This invention relates to a transport deck for a pickup truck and more particularly to a transport deck for a pickup truck which is movably mounted in the box of the pickup truck so as to be selectively movable between a transport position in the box of the pickup truck to a horizontally disposed loading/unloading position rearwardly of the pickup truck.

2. Description of the Related Art

Owners of all-terrain vehicles, snowmobiles, garden tractors, riding mowers, etc. frequently need to transport the vehicles and other equipment from one location to another. In many cases, the vehicles are loaded onto the truck beds or pickup boxes by means of ramps which extend downwardly and rearwardly from the rearward end of the bed or box. The ramps may be difficult to properly position and may not always remain in a secure position making it difficult to load the vehicle onto the truck and to unload the same from the truck. Further, the use of ramps which extend downwardly and rearwardly from the truck bed or box are steeply inclined which makes it difficult to move the vehicles upwardly on the ramps and move the vehicles downwardly on the ramps.

Applicant's invention described in U.S. Pat. No. 8,021,096 represents a significant advance in the art. In Applicant's earlier invention, the truck bed thereof was designed to be placed on the rear end of a wheeled frame of a truck and was not designed to be used in a pickup box. Although Applicant's earlier invention performs satisfactorily, it has been found that some owners of pickup trucks are reluctant to remove the pickup boxes therefrom to enable to mount Applicant's earlier invention thereon. The instant invention is designed to permit a transport or support deck to be movably positioned within the box of a pickup truck.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A transport deck for a pickup truck is disclosed which is selectively movably positioned within the box of a pickup truck rearwardly of the cab of the pickup truck from a transport position to a loading/unloading position rearwardly of the vehicle. A deck support frame is secured to the floor of the pickup box rearwardly of the cab of the pickup truck and includes longitudinally extending first and second horizontally disposed and horizontally spaced frame rails with forward and rearward ends. A movable carriage assembly is longitudinally movably mounted on the deck support frame. The carriage assembly includes: (a) an elongated front support, having first and second ends, extending between the first and second frame rails of the deck support frame; (b) a first roller mounted on the first end of the first support which movably engages the first frame rail of the deck support frame; (c) a second roller mounted on the second end of the first support which movably engages the second frame rail of the deck support frame; (d) an elongated intermediate support spaced rearwardly of the front support and which has first and second ends with the intermediate support extending between the first and second frame rails of the deck support frame; (e) a third roller mounted on the first end of the intermediate support which movably engages the first frame rail of the deck support frame; (f) a fourth roller mounted on the second end of the intermediate support which movably engages the second frame rail of the deck support frame; (g) a rear support, having forward and rearward ends, secured to the intermediate support and which extends rearwardly from the intermediate support; (h) a fifth roller secured to the rear support adjacent the rearward end thereof which movably engages one of the first and second frame rails of the deck support frame; (i) a first power cylinder which is movable between retracted and extended positions and which has a base end and a rod end; (j) the base end of the first power cylinder is secured to the front support; (k) the rod end of the first power cylinder is secured to the intermediate support; (l) a second power cylinder which is movable between retracted and extended positions and which has a base end and a rod end; (m) the base end of the second power cylinder is secured to the deck support adjacent the forward end thereof; (n) the rod end of the second power cylinder is secured to the rear support; (o) a pair of elongated pivot arms having first and second ends; (p) the first ends of the pivot arms being operatively pivotally secured to the front support; (q) a deck connector having a first connector portion, an intermediate connector portion and a second connector portion; (r) the rearward end of the first connector portion is pivotally secured to the intermediate support; (s) the first connector portion is pivotally connected to the pair of pivot arms between the pivotal connection of the first connector portion with the intermediate portion and the intermediate connector portion.

A transport deck is movably positioned on the deck support rearwardly of the cab with the transport deck including a support deck portion having a forward end, a rearward end and opposite sides. The transport deck also includes an upstanding front wall having rearward and forward sides. The upper end of the third connector portion is pivotally secured, about a horizontal axis, to the upper end of the front wall of the transport deck. The transport deck is selectively movable between a transport position wherein the support deck portion is in a horizontally disposed position over the floor of the box of the pickup truck and a loading/unloading position wherein the support deck portion is positioned rearwardly of the pickup truck in a horizontally disposed manner. The first power cylinder is in its extended position when the transport deck is in its transport position and is in its retracted position when the transport deck is in its loading/unloading position. The second power cylinder is in its retracted position when the transport deck is in its transport position and is in its extended position when the transport deck is in its loading position. The third connector portion of the deck connector is positioned forwardly of the front wall of the transport deck when the transport deck is in its transport position.

It is therefore a principal object of the invention to provide an improved transport deck which may be mounted in the box of a pickup truck.

A further object of the invention is to provide an improved transport deck for a pickup truck which is selectively movable between a transport position on the pickup truck to a to a horizontally disposed loading/unloading position rearwardly of the pickup truck.

A further object of the invention is to provide a transport deck for a pickup truck wherein the transport deck may be moved from a transport position to a loading position rearwardly of the pickup truck so that a vehicle such as an ATV, snowmobile, garden tractor, lawn mower, etc. may be loaded onto the transport deck when in its loading position with the transport deck then being raised upwardly and forwardly into the box of the pickup truck to its transport position.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a partial perspective view of a pickup truck having the transport deck of this invention mounted in the box thereof;

FIG. 2 is a front perspective view of the transport deck of this invention;

FIG. 3 is a schematic view of the hydraulic circuitry of this invention;

FIG. 4 is a bottom perspective view of the transport deck of this invention;

FIG. 5 is a perspective view of the carriage assembly of this invention and its related structure;

FIG. 6 is a side elevational view of the transport deck of this invention being pivotally moved within the pickup box;

FIG. 7 is a rear sectional view of the transport deck of this invention mounted in the box of a pickup truck;

FIG. 8 is a side elevational view illustrating the transport deck of this invention in its transport position;

FIG. 9 is a view similar to FIG. 8 except that the transport deck has been partially moved towards its loading/unloading position; and

FIG. 10 is a view similar to FIGS. 8 and 9 except that the transport deck has been moved rearwardly and lowered from the position of FIG. 9 with the broken lines illustrating the transport deck in its loading/unloading position.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

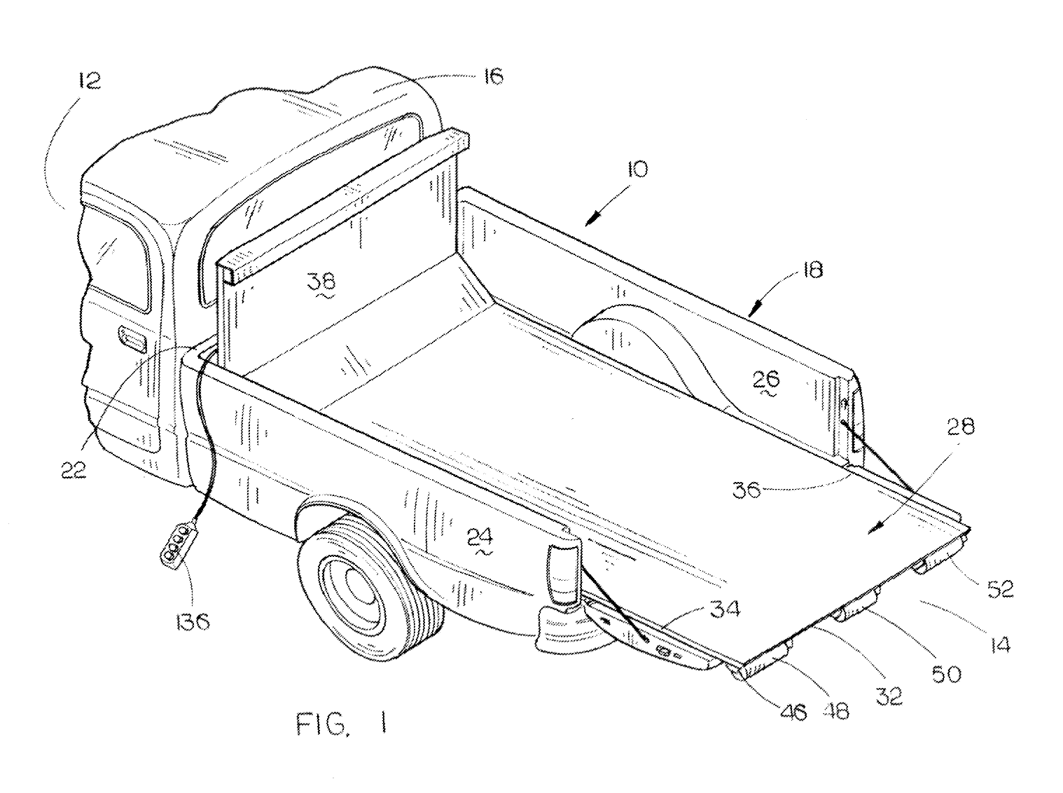

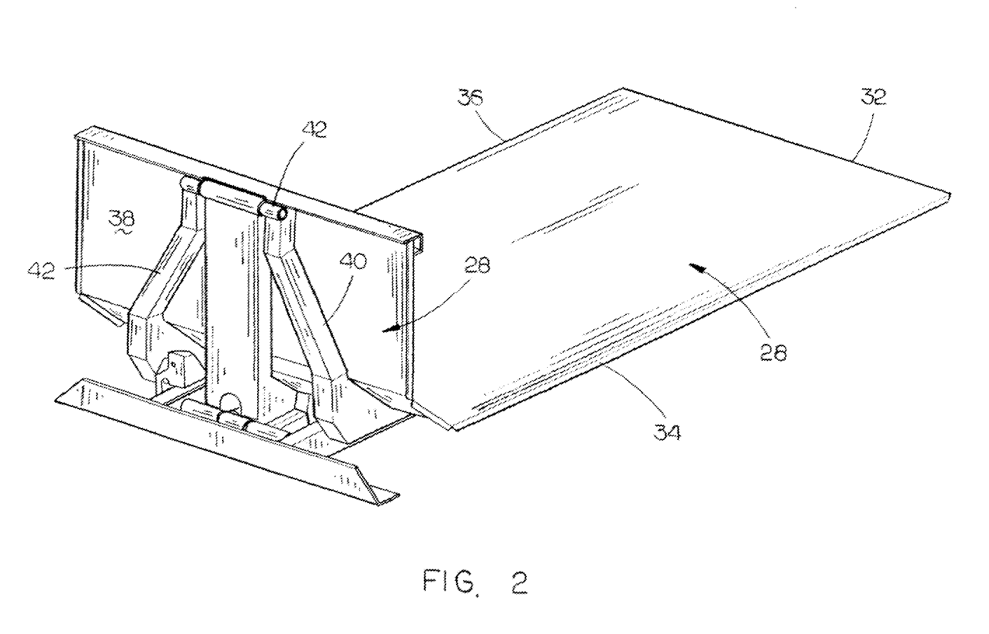

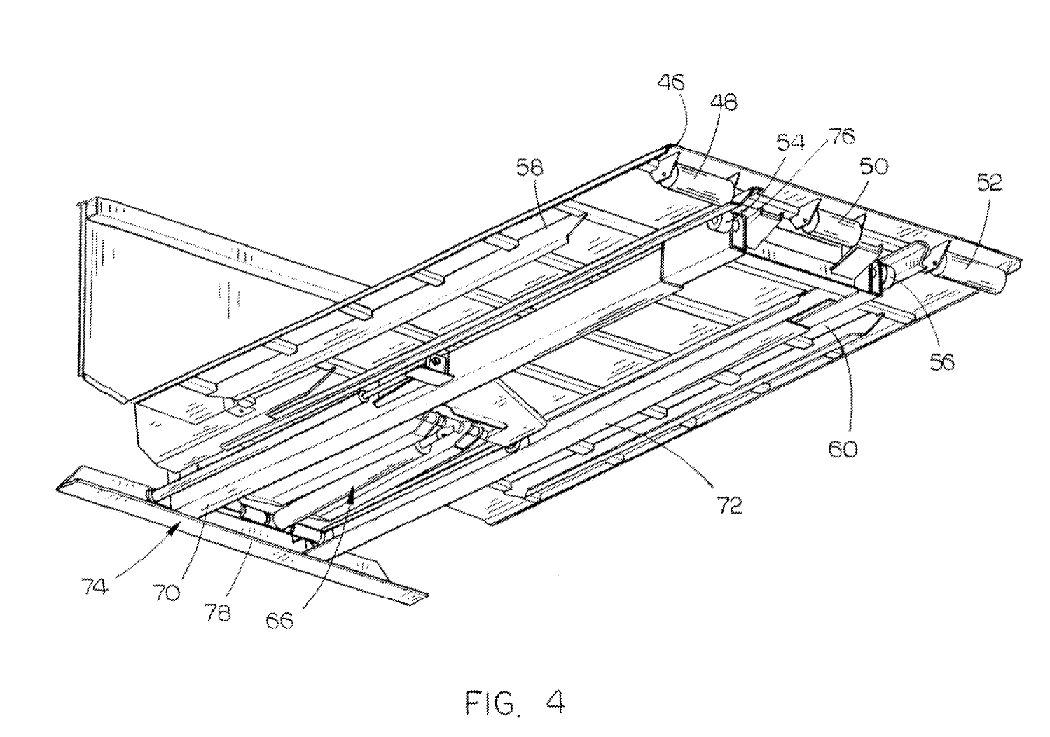

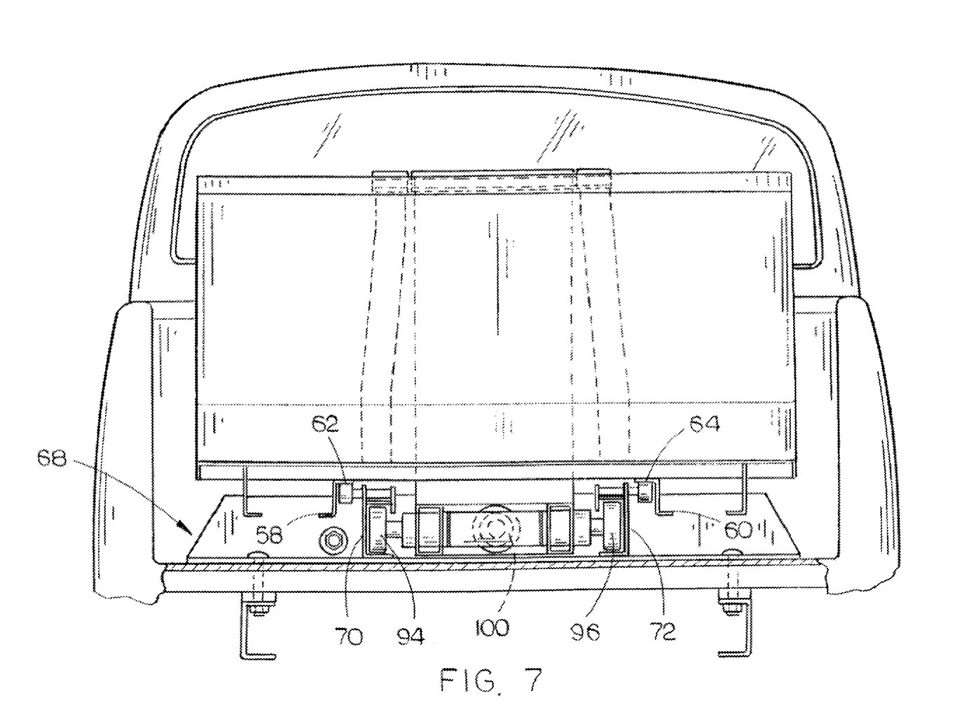

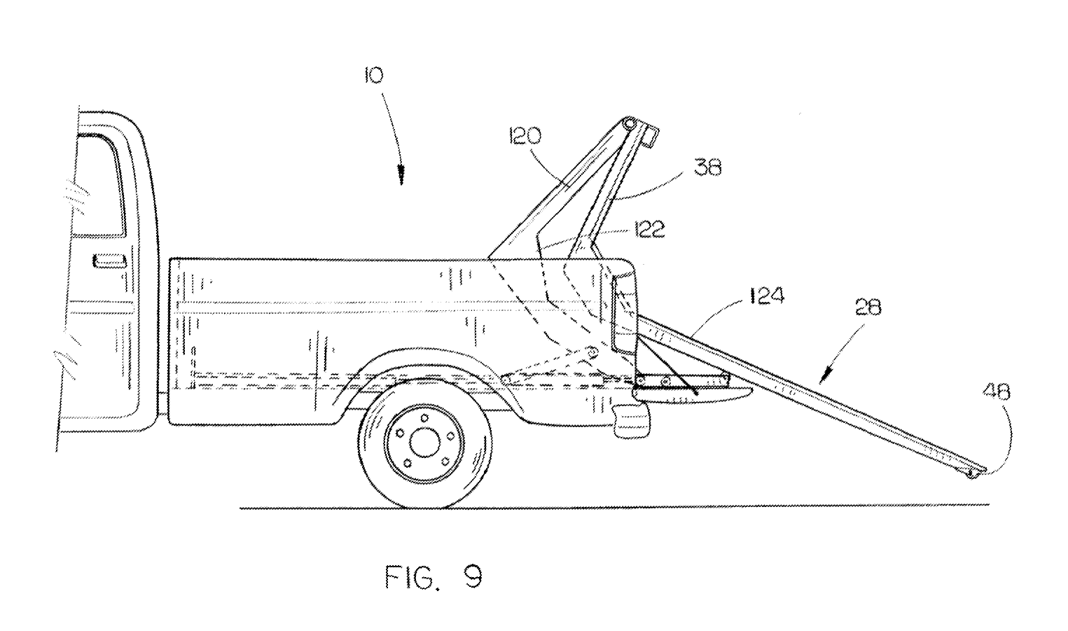

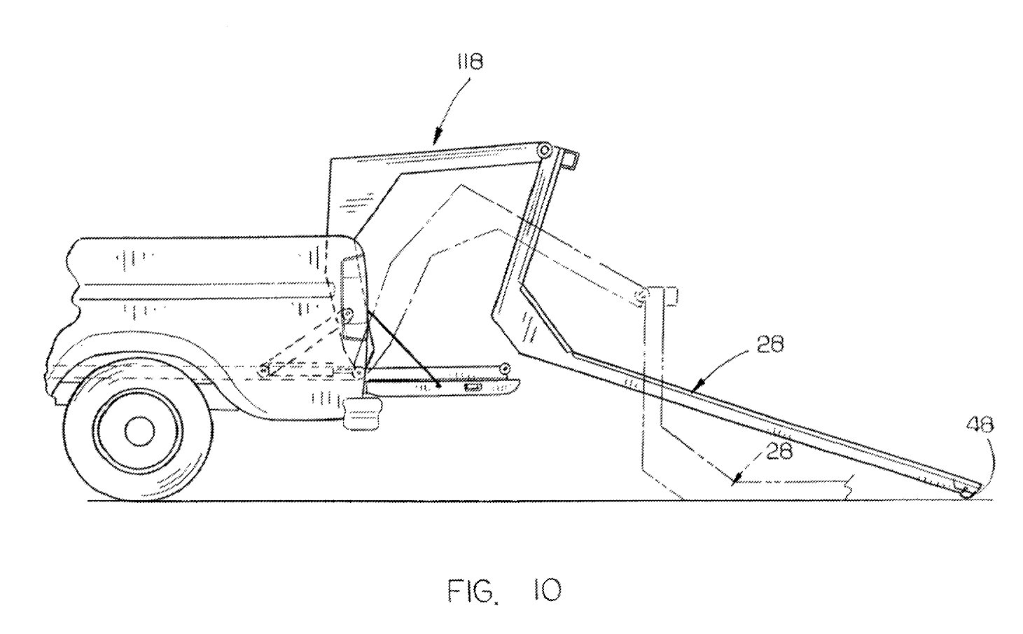

The numeral 10 refers to a conventional pickup truck including a forward end 12 and a rearward end 14. Pickup truck 10 includes a cab 16 and a box 18 mounted on the frame of the pickup truck in conventional fashion. The pickup truck box 18 includes a floor 20, front wall 22 and side walls 24 and 26. The pickup truck 10 has a transport deck 28 movably mounted thereon having a forward end 30, a rearward end 32 and opposite sides 34 and 36. As seen in FIG. 2, transport deck 28 includes an upstanding front wall 38 having horizontally spaced-apart and vertically disposed support posts or frame members 40 and 42 secured to the forward side thereof. A horizontally extending pivot rod 42 is secured to and extends between the upper ends of posts 40 and 42, as seen in FIG. 2. The upper surface of transport deck 28 preferably has an irregular surface thereon to enable a vehicle such as an ATV, snowmobile, etc. to drive thereon as will be described hereinafter. The rearward end of transport deck 28 is preferably tapered or beveled at 46, as seen in FIGS. 9 and 10. Rollers 48, 50 and 52 are rotatably mounted on the underside of transport deck 28, as seen in FIG. 1. A pair of rollers 54 and 56 are rotatably mounted on the underside of transport deck 28 forwardly of rollers 48, 50 and 52 (FIG. 4). A pair of longitudinally extending guide rails 58 and 60 are secured to the underside of transport deck 28, as seen in FIG. 4, and have guide surfaces 62 and 64 provided thereon respectively, as seen in FIG. 7.

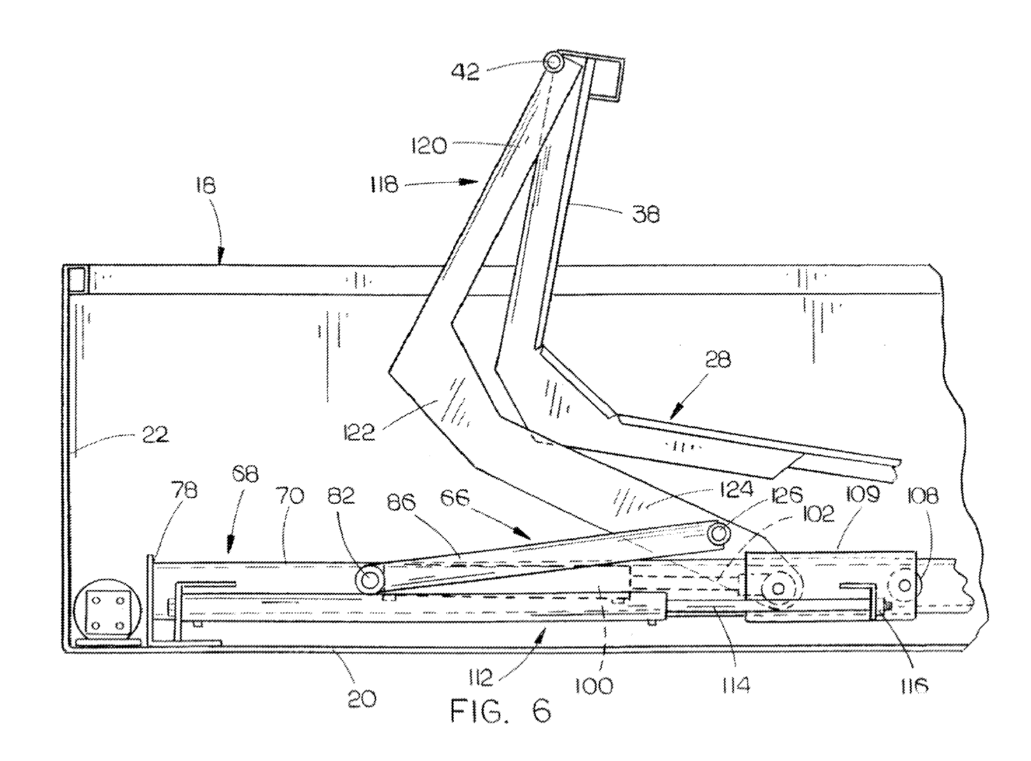

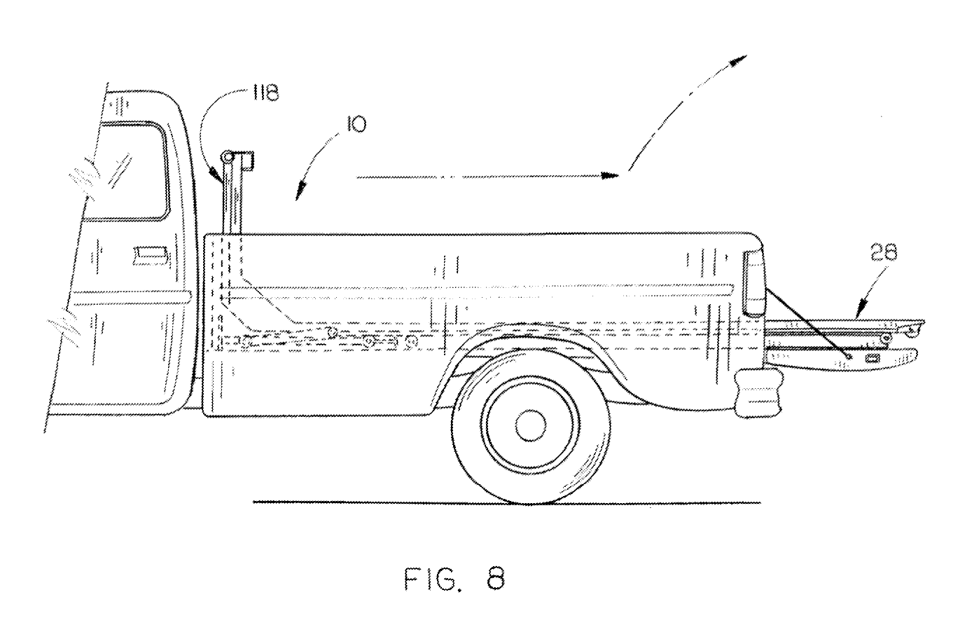

The mechanism for selectively moving the transport deck 28 between its normal transport position of FIGS. 1 and 8 and the loading/unloading position illustrated by broken lines in FIG. 10 is best illustrated in FIGS. 4-6 and which is generally designated by the reference numeral 66. Mechanism 66 includes a frame means 68 having a pair of channel-shaped frame members 70 and 72 extending between the forward end 74 of frame means 68 and the rearward end 76 of frame means 68. The forward ends of frame members 70 and 72 have a cross-member 78 secured thereto and extending therebetween.

Mechanism 66 also includes a carriage assembly 80 which is movably mounted on the frame means 68. Carriage assembly 80 includes a front shaft or support 82 having rollers 84 and 86 rotatably mounted on the ends thereof. Rollers 84 and 86 are movably received within the frame members 70 and 72 respectively. A pair of elongated arms 88 and 90 have their forward ends secured to front shaft 82 and extend rearwardly therefrom.

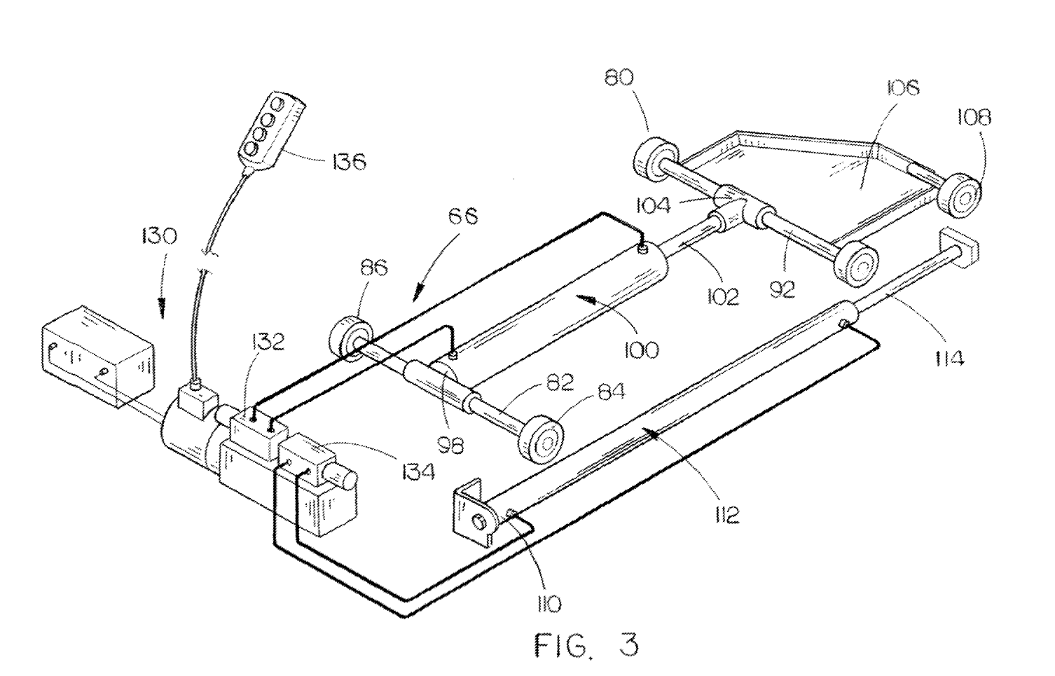

Carriage assembly 80 also includes a rear shaft or support 92 having rollers 94 and 96 rotatably mounted on the ends thereof. Rollers 94 and 96 are movably received within the frame members 70 and 72 respectively rearwardly of the rollers 84 and 86. The forward or base end 98 of hydraulic cylinder 100 is secured to front shaft 82 (FIG. 3). The cylinder rod 102 of cylinder 100 is secured to rear shaft 92 at 104. Cylinder 100 is a double acting cylinder so that the rod 102 may be retracted and extended in conventional fashion. Although it is preferred that cylinder 100 is a hydraulic cylinder, cylinder 100 could be a pneumatic cylinder or an electrically powered screw actuator.

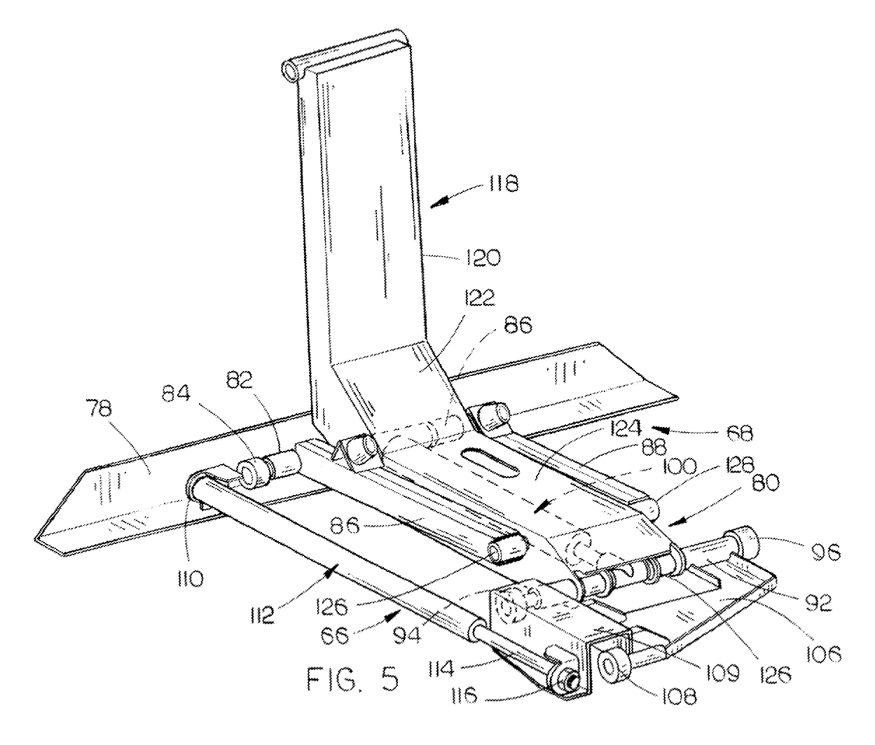

A support 106 is secured to rear shaft 92 and extends rearwardly therefrom. Roller 108 is rotatably mounted on the rearward end of support 106 and is received within frame member 109 which is slidably mounted on frame member 20 and which is fixed to support 106. (FIG. 5). The forward end 110 of hydraulic cylinder 112 is secured to the cross-member 78 (FIG. 5) with the cylinder 112 extending rearwardly therefrom. The rod 114 of cylinder 112 is secured to frame member 109 adjacent the rearward end thereof at 116. This extension of cylinder 40d 114 causes carriage 80 to be moved rearwardly with respect to frame members 70 and 72. The retraction of cylinder rod 114 causes the carriage assembly 80 to be moved forwardly with respect to frame members 70 and 72.

A gooseneck-like frame member or connector member 118 including frame or connector portions 120, 122 and 124 is provided for interconnecting the transport deck 28 to the carriage assembly 80. The rearward end of frame portion 124 is pivotally mounted on the shaft 92 at 126 about a horizontal axis. The rearward ends of arms 86 and 88 are pivotally secured to frame portion 124 at 126 and 128 respectively which is above and forwardly of the pivotal connection 126. The upper end of frame portion 120 is pivotally connected to the pivot rod 42.

The numeral 130 refers to an electrically powered hydraulic pump assembly including a valve 132 from controlling the operation of the double acting hydraulic cylinder 100 and a valve 134 for contracting the operation of the double acting hydraulic cylinder 112. Preferably, the valves 132 and 134 are remotely radio controlled but may be controlled by a hard-wired controller.

In operation, assuming that the transport deck 28 is in the transport position of FIG. 1, the transport deck 28 is selectively movable from the transport position to the loading/unloading position as illustrated in FIG. 10. The first step in the process is to extend cylinder 100 to pivotally move the connector member 118 from the position of FIG. 8 towards the position of FIG. 9. Cylinder 112 is then extended to cause the carriage assembly 80 to be moved rearwardly so that the transport deck 28 is moved rearwardly with respect to the pickup box in conjunction with the pivotal movement of the connector member 118. The cylinder 100 is further extended and the cylinder 110 is extended to cause the transport deck to be moved from the position of FIG. 1 to the broken line position of FIG. 10.

With the transport deck 28 resting on the ground, an ATV or other vehicle may be driven onto the transport deck 28 and secured thereto. The hydraulic cylinder 100 is then retracted and the cylinder 112 is retracted to move the transport deck back upwardly and forwardly onto the vehicle to the position of FIG. 1. The rollers at the rearward end of the transport deck 28 to permit the transport deck 28 to roll along the ground during the movement of the transport deck during the movement of the transport deck from the position illustrated in FIG. 10. The rollers also facilitate the movement of the transport deck with respect to the pickup box.

Thus it can be seen that a novel transport deck has been provided which is easily and conveniently mounted in the box of a pickup truck. The transport deck is in a horizontally disposed position when in its transport position and when in its loading/unloading position. Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. In combination:
a pickup truck having forward and rearward ends;
said pickup truck including a cab at the forward end thereof;
said pickup truck including a wheeled frame which extends rearwardly from said cab;
a pickup box secured to said wheeled frame rearwardly of said cab;
said pickup box including a floor, a front wall, and first and second sidewalls;
an elongated transport deck support frame means positioned on and secured to said floor of said pickup box between said sidewalls thereof;
said transport deck support frame means including a first elongated, horizontally disposed and longitudinally extending channel-shaped frame rail having a forward end and a rearward end;
said transport deck support frame means also including a second elongated, horizontally disposed and longitudinally extending channel-shaped frame rail having a forward end and a rearward end;
said first and second frame rails being horizontally spaced-apart;
a movable carriage assembly longitudinally movably mounted on said first and second frame rails;
said carriage assembly including:
(a) an elongated front support, having first and second ends, extending between said first and second frame rails of said transport deck support frame means;
(b) a first roller mounted on said first end of said front support which movably engages said first frame rail of said transport deck support frame means;
(c) a second roller mounted on said second end of said front support which movably engages said second frame rail of said transport deck support frame means;
(d) an elongated intermediate support spaced rearwardly of said front support, having first and second ends, extending between said first and second frame rails of said transport deck support frame means;
(e) a third roller mounted on said first end of said intermediate support which movably engages said first frame rail of said transport deck support frame means;
(f) a fourth roller mounted on said second end of said intermediate support which movably engages said second frame rail of said transport deck support frame means;
(g) a rear support secured to said intermediate support which extends rearwardly from said intermediate support;
(h) a fifth roller secured to said rear support which movably engages one of said first and second frame rails;
(i) a first power cylinder, being movable between retracted positions and having a base end and a rod end;
(j) said base end of said first power cylinder being operatively secured to said front support;
(k) said rod end of said first power cylinder being operatively secured to said intermediate support;
(l) a second power cylinder being movable between retracted and extended positions and having a base end and a rod end;
(m) said base end of said second power cylinder being secured to said transport deck support frame means adjacent the forward end thereof;
(n) said rod end of said second power cylinder being secured to said rear support;
(o) a pair of elongated pivot arms having first and second ends;
(p) said first ends of said pivot arms being operatively pivotally secured to said front support;
(q) a deck connector having a first connector portion and a second connector portion;
(r) said first connector portion being pivotally secured to said intermediate support;
(s) said first connector portion being pivotally connected to said pair of pivot arms between the pivotal connection of said first connector portion with said intermediate support and said second connector portion;
a transport deck positioned on said transport deck support frame means rearwardly of said cab;
said transport deck including a deck portion having a forward end, a rearward end, and opposite sides;
said transport deck also including an upstanding front wall having rearward and forward sides;
said second connector portion being pivotally secured, about a horizontal axis, to said front wall of said transport deck at the upper end thereof;
said transport deck being selectively movable between a transport position wherein said deck portion is in a horizontally disposed position over said floor of said pickup box and a loading/unloading position wherein said deck portion is positioned rearwardly of said rearward end of said pickup truck in a horizontally disposed position;
said first power cylinder being in its retracted position when said transport deck is in its said transport position and being in its extended position when said transport deck is in its said loading position;
said second power cylinder being in its said retracted position when said transport deck is in its said transport position and being in its said extended position when said transport deck is in its said loading/unloading position; and
said second connector portion of said deck connector being positioned forwardly of said front wall of said transport deck when said transport deck is in its said transport position.
